(19) United States
(12) Patent Application Publication
(10) Pub. No.: US 2007/0081327 A1
(43) Pub. Date: Apr. 12, 2007

(54) High power light-emitting flashlight

(76) Inventor: Chin-Pei Chang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/246,082

(22) Filed: Oct. 11, 2005

(51) Int. Cl. F21L 4/00

(52) U.S. Cl. 362/157

(57) ABSTRACT

A high power light-emitting flashlight includes a lampshade, a first tube, a second tube, and a base cover screwed to one another; the first tube containing a lamp holder and a power socket, the lamp holder including a carrier, an LED circuit board mounted with an LED lamp, and a retainer; the LED circuit board being disposed to the carrier; and the retainer and the carrier being inserted to each other to clamp the LED circuit board in place.

### BACKGROUND OF THE INVENTION

(a) Field of the Invention

The present invention is related to a flashlight, and more particularly to a high power light-emitting flashlight permitting easy assembly.

(b) Description of the Prior Art:

Usually an LED flashlight is comprised of complicate members and it takes a circuit board for the flashlight to emit light. Therefore, how to deploy a power circuit board to the LED lamp within a very limited space is a key issue challenging the design of the assembly of the LED flashlight.

Meanwhile the circuit board also functions as the heat dissipation interface for the LED lamp. Heat dissipation adds further difficulty in the design of the LED flashlight thanks to the presence of a heat sink substrate. All these prevent easy adaptation of the LED lamp to the flashlight.

### SUMMARY OF THE INVENTION

The primary purpose of the present invention is to provide a high power light-emitting flashlight that allows easy assembly. To achieve the purpose, the present invention is essentially comprised of a lampshade, a first tube, a second tube, and a base cover.

The lampshade includes a first end and a second end with both ends staying comparatively far apart from each other, and both ends are hollowed out with the first end disposed with a light permeable lens.

The first tube includes a third end and a fourth end with both ends again staying comparatively far apart from each other; the third end of the first tube and the second end of the lampshade are screwed to each other; a through hole is disposed on the wall of the first tube; and the first tube contains a lamp holder and a power socket. The lamp holder includes a carrier, an LED circuit board mounted with an LED lamp, and a retainer. The LED circuit board is disposed on the carrier; and the retainer and the carrier are inserted into each other to clamp the LED circuit board in place. The power socket includes a left casing, a right casing and a control circuit board. Both of the left and the right casings are abutted to each other to clamp the control circuit board in position. An opening is provided to the left casing to accommodate the installation of a pushbutton to drive the control circuit board with the pushbutton exposed from the through hole of the first tube. The LED circuit board of the lamp holder is electrically connected to each other with the control circuit board from the power socket.

The second tube is provided with a fifth end and a sixth end. Both ends stay comparatively far apart from each other. The fifth end of the second tube and the fourth end from the first tube are screwed to each other. The second tube contains a battery holder electrically connected to the control circuit board.

The base cover is screwed to the sixth end of the second tube.

### BRIEF DESCRIPTION OF THE DRAWINGS

FIG. 1 is a perspective view of a preferred embodiment of the present invention.

FIG. 2 is an exploded view of the preferred embodiment of the present invention.

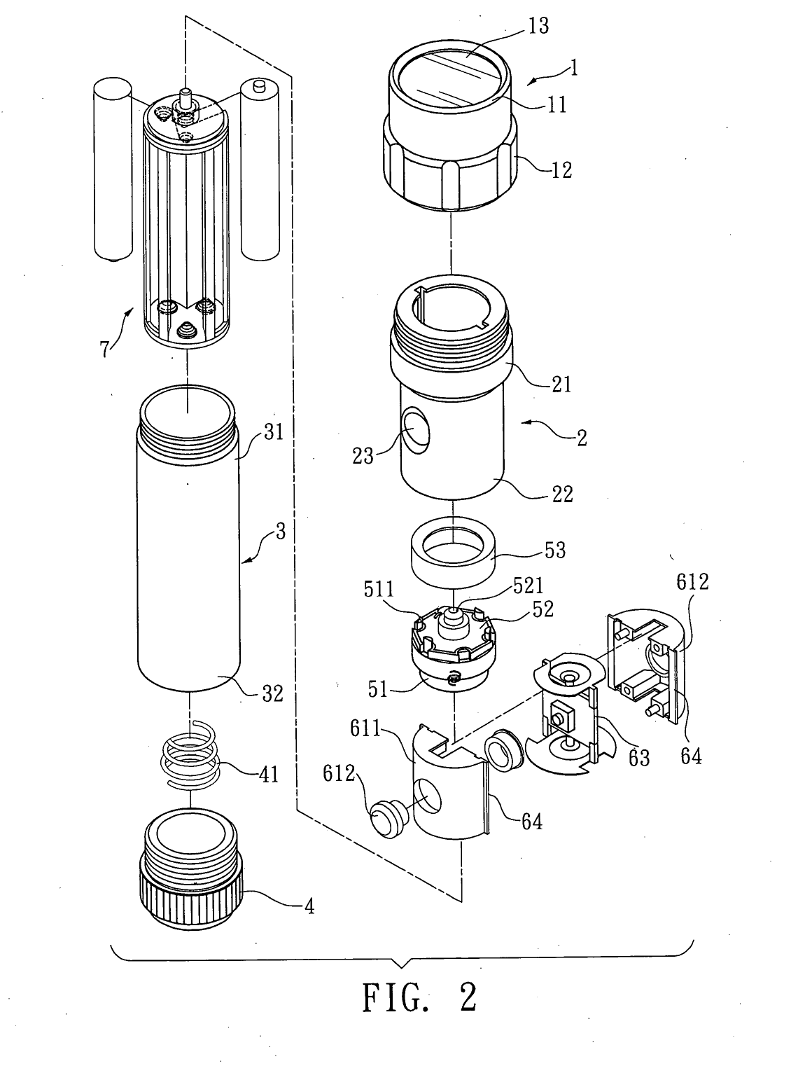

FIG. 3 is a schematic view showing the construction of the preferred embodiment of the present invention.

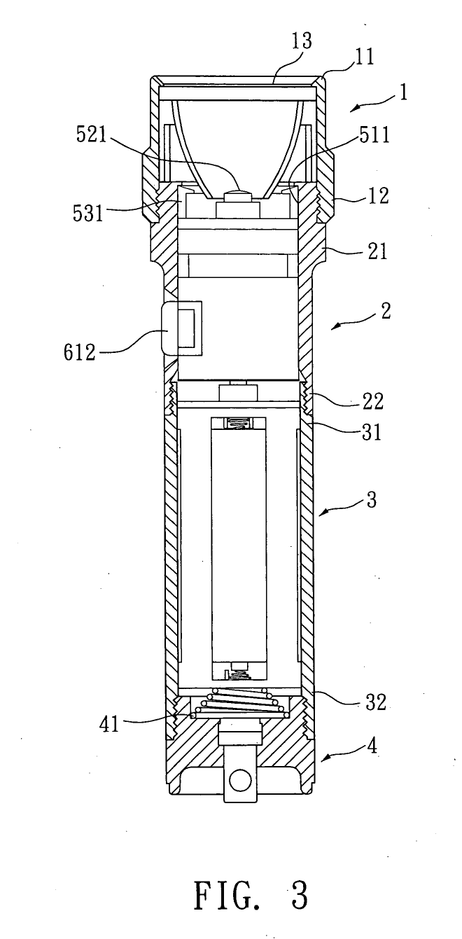

FIG. 4 is a schematic view showing the appearance of the construction of a carrier and a retainer of the preferred embodiment of the present invention.

### DETAILED DESCRIPTION OF THE PREFERRED EMBODIMENTS

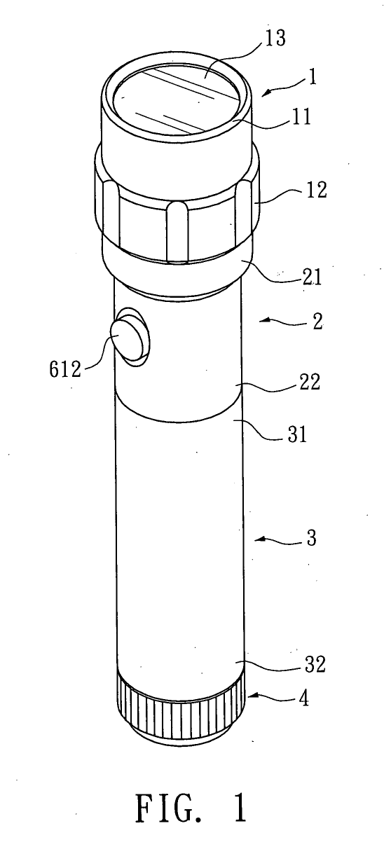

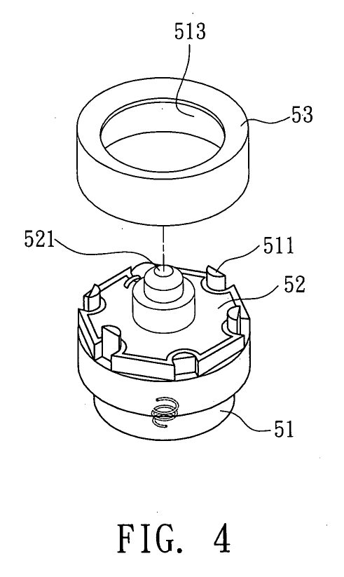

Referring to FIGS. 1 and 4 for a preferred embodiment of the present invention. It is to be noted that the preferred embodiment given here is only for the convenience to describe the construction of the present invention and in no way limits what is to be claimed in this application.

The preferred embodiment includes a lampshade 1, a first tube 2, a second tube 3, and a base cover 4.

The lampshade 1 includes a first end 11 and a second end 12 staying comparatively far apart from each other; both ends of the lampshade 1 are hollowed out; with the first end 11 disposed with a light permeable lens 13.

The first tube 2 includes a third end 21 and a fourth end 22 with both ends again staying comparatively far apart from each other. The third end 21 of the first tube 2 and the second end 12 of the lampshade 1 are screwed to each other. A through hole 23 is disposed on the wall of the first tube 2; and the first tube 2 contains a lamp holder 5 and a power socket 6.

The lamp holder 5 includes a carrier 51, an LED circuit board 52 mounted with an LED lamp 521, and a retainer 53. The LED circuit board 52 is disposed on the carrier 51. Multiple studs 511 are disposed on the perimeter closer to the carrier. A surrounding inner wall 531 is provided to the retainer 53. Each stud 511 and the inner wall 531 of the retainer 53 rest upon each other. The retainer 53 and the carrier 51 are inserted into each other to clamp the LED circuit board 52 in place.

The power socket 6 includes a left casing 61, a right casing 62 and a control circuit board 63. Both of the left and the right casings 61, 62 are abutted to each other to clamp the control circuit board 63 in position. An opening 611 is provided to the left casing 61 to accommodate the installation of a pushbutton 612 to drive the control circuit board 63 with the pushbutton 612 exposed from the through hole 23 of the first tube 2. The LED circuit board 52 of the lamp holder 5 is electrically connected to each other with the control circuit board 63 from the power socket 6. Two wings 64 protrude sideway from the power socket 6 with both wings 64 penetrating through a rail (not illustrated) provided axially in the first tube 2.

The second tube 3 is provided with a fifth end 31 and a sixth end 32. Both ends 31, 32 stay comparatively far apart from each other. The fifth end 31 of the second tube 3 and the fourth end 22 from the first tube 2 are screwed to each other. The second tube 3 contains a battery holder 7 electrically connected to the control circuit board 63.

The base cover 4 is screwed to the sixth end 32 of the second tube 3. A coil 41 is provided to the base cover 4 to push the battery holder 7 to press tightly upon the power socket.

Both of the retainer 53 and the carrier 51 are inserted to each other so to clamp the LED circuit board 52 in position to help heat dissipation by the LED lamp while providing easy and efficient assembly of the flashlight.

1. A high power light-emitting flashlight is comprised of a lampshade, a first tube, a second tube, and a base cover; the lampshade including a first end and a second end with both ends staying comparatively far apart from each other, and both ends being hollowed out with the first end disposed with a light permeable lens;
the first tube including a third end and a fourth end with both ends again staying comparatively far apart from each other; the third end of the first tube and the second end of the lampshade are screwed to each other; a through hole being disposed on the wall of the first tube; the first tube containing a lamp holder and a power socket; the lamp holder including a carrier, an LED circuit board mounted with an LED lamp, and a retainer; the LED circuit board being disposed on the carrier; the retainer and the carrier being inserted into each other to clamp the LED circuit board in place; the power socket including a left casing, a right casing and a control circuit board; both of the left and the right casings being abutted to each other to clamp the control circuit board in position; an opening being provided to the left casing to accommodate the installation of a pushbutton to drive the control circuit board with the pushbutton exposed from the through hole of the first tube; the LED circuit board of the lamp holder being electrically connected to each other with the control circuit board from the power socket; the second tube being provided with a fifth end and a sixth end; both ends staying comparatively far apart from each other; the fifth end of the second tube and the fourth end from the first tube being screwed to each other; and the second tube containing a battery holder electrically connected to the control circuit board; and the base cover being screwed to the sixth end of the second tube.

2. The high power light-emitting flashlight of claim 1, wherein multiple studs are disposed on the perimeter closer to the carrier; a surrounding inner wall is provided to the retainer; and each stud and the inner wall of the retainer rest upon each other.

3. The high power light-emitting flashlight of claim 1, wherein a rail is disposed axially to the first tube; two wings respectively protrude sideway from both sides of the power socket; and both wings penetrate through the rail of the first tube.
